(19) United States
(12) Patent Application Publication
(10) Pub. No.: US 2014/0321030 A1
(43) Pub. Date: Oct. 30, 2014

(54) SOLID ION CAPACITOR AND METHOD FOR USING SOLID ION CAPACITOR

(71) Applicants: Tokyo Institute of Technology, Tokyo (JP); MURATA MANUFACTURING CO., LTD., Nagaokakyo-Shi (JP); TDK Corporation, Tokyo (JP); Taiyo Yuden Co, Ltd., Tokyo (JP)

(72) Inventor: Takaaki Tsurumi, Tokyo (JP)

(21) Appl. No.: 14/327,852

(22) Filed: Jul. 10, 2014

Related U.S. Application Data
(63) Continuation of application No. PCT/JP2013/051405, filed on Jan. 24, 2013.

(30) Foreign Application Priority Data
Jan. 27, 2012 (JP) 2012-015349

(51) Int. Cl. H01G 9/15

(52) U.S. Cl. CPC H01G 9/15
USPC 361/525

(57) ABSTRACT

A solid ion capacitor having electrodes on both principal surfaces of a solid electrolyte having a thickness no greater than 200 μm. The solid electrolyte contains an ion conductive compound having a Nasicon type crystal structure, and the ion conductive compound includes at least Li, Al, P, and O. The electrodes are formed from a non-valve action material which does not have a valve action. The interface between the solid electrolyte and the electrodes has a fine uneven structure. This solid ion capacitor is used at a driving voltage of no greater than 3 V, or preferably 1.5 to 3 V.

### CROSS REFERENCE TO RELATED APPLICATIONS

This application is a continuation application of international patent application Serial No.PCT/JP2013/051405, filed 24 Jan. 2013, which published as PCT Publication No. WO2013/111804 on 1 Aug. 2013, which claims benefit of Japan patent application No. 2012-015349, filed 27 Jan. 2012, the entire content of each of which are incorporated herein by reference.

### FIELD OF THE INVENTION

The present invention relates to a solid ion capacitor and a method for using a solid ion capacitor, and more particularly relates to a solid ion capacitor that stores electricity by using a solid electrolyte and a method for using the same.

### BACKGROUND OF THE INVENTION

With the diffusion of various electronic apparatus such as cellular phones, laptop personal computers, and digital cameras, research and development of various electrical storage devices are actively carried out as a cordless power source for these electronic apparatus. Further, among these electrical storage devices, an electric double layer capacitor is widely used as a backup power source for a memory of the personal computer, an auxiliary power source for a hybrid automobile, or the like because high-speed charging/discharging can be made and little deterioration of performance occurs even when charging/discharging is repetitively carried out.

The electric double layer capacitor makes use of the fact that, when a voltage is applied, an electric double layer is formed between the positive electrode or negative electrode and the electrolyte. Electric charge is stored by forming an electric double layer during the charging, and the charged particles, by discharging, return to the state before charging, so that the electric double layer capacitor does not make use of a chemical reaction, and it is conceivable that little heat generation or deterioration occurs even when charging/discharging is repetitively carried out, furthermore, quick charging/discharging can be made at high efficiency, and excellent cycle characteristics can be obtained.

Further, the document 1 discloses an all-solid type electric double layer capacitor provided with a solid electrolyte and a collector, in which the solid electrolyte consists of an inorganic compound.

In the document 1, a solid electrolyte made of an inorganic compound is used so as to avoid generation of liquid leakage, because there is a fear that deterioration by liquid leakage may occur when a liquid electrolyte (electrolytic solution) is used.

That is, in the document 1, a Li ion conductive compound having a Nasicon type crystal structure represented by Li_{1.3}Al_{0.3}Ti_{1.7}(PO₄)₃ is used, and a solid electrolyte mainly containing the Li ion conductive compound and having a diameter of 14.5 mm and a thickness of 0.97 mm is manufactured. Further, electrodes made of Au are formed on both surfaces of this solid electrolyte, thereby to obtain an all-solid type electric double layer capacitor having a capacitance of 20 μF.

The document 1: JP No. 2008-130844 A (claim 1, pars. [0009]-[0010], Table 1, and so forth)

### SUMMARY OF THE INVENTION

In a conventional electric double layer capacitor, in case of using a liquid electrolyte, for example, the thickness of the electric double layer is as thin as several nanometers or several tens of nanometers, so that the part other than the electric double layers located in the near-field of the positive electrode and the negative electrode simply functions as a conductor. Further, in the part other than the electric double layers, cations and anions are both movable in the liquid electrolyte and the cations are attracted to the anions in the near-field of the positive electrode, and the anions are attracted to the cations in the near-field of the negative electrode. Therefore, the area where an electric field is applied (hereafter referred to as an “electric field application area”) is restricted to the near-field area of each of the positive electrode and the negative electrode, and shielding is made so that the electric field application area does not penetrate into the inside of the liquid electrolyte. Therefore, the voltage (electric field) applied at the time of charging is applied only to the electric double layer, so that the electric field does not change even when the distance between the positive electrode and the negative electrode is shortened, and the electric field does not depend on the thickness of the liquid electrolyte. For this reason, in order to increase the capacitance of the electric double layer capacitor, the specific surface area of the electrodes must be increased and, even if the specific surface area is increased, it is difficult to obtain a desired sufficiently large capacitance.

Also, in the above-mentioned document 1, although a Li ion-conducting compound having a Nasicon type crystal structure is used as the solid electrolyte, in this case also, it is difficult to obtain a desired large capacitance due to the following reason.

That is, in a Li ion conductive compound having a Nasicon type crystal structure, when a voltage is applied between the positive electrode and the negative electrode at the time of charging, the anions are present in the crystal lattice and do not move, and only the cations move, so that there is no shielding of the electric field application area as described above, whereby increase in the electric field application area can be expected. Further, it is conceivable that, since the polarization increases by the electric charge that moves by the electric field, the electric charge stored in the positive electrode and the negative electrode increases, so that the capacitance per volume can be increased.

However, in the document 1, the thickness of the solid electrolyte is as large as 0.97 mm and, for this reason, the electric field application area per volume in the solid electrolyte cannot be increased, and the state in which the electric double layer is formed at the interface between the positive electrode or negative electrode and the solid electrolyte is maintained. Therefore, in the same manner as described above, the voltage applied at the time of charging is applied only to the electric double layer and, for this reason, it is difficult to obtain a desired large capacitance.

The present invention has been made in view of such a situation, and it is an object of the invention to provide a solid ion capacitor that is small and capable of achieving a large capacitance by using a solid electrolyte, and a method for using the solid ion capacitor.

The present inventor has made studies using a solid electrolyte in which ions move in a solid state, and has found that the capacitance per electrode area, that is, the specific capacitance, increases in accordance with the reduction in the layer thickness of the solid electrolyte and that, by setting the thickness to be no greater than 200 μm, the capacitance increases in an outstanding manner as compared with a conventional electric double layer capacitor.

The present invention has been made based on such a finding, and the solid ion capacitor according to the present invention is characterized by having a solid electrolyte formed to have a thickness no greater than 200 μm.

This allows that the electric field is applied to the whole solid electrolyte, and the electric charge in the near-field of the electrode can move to the near-field of the electrode on the opposite side, so that extremely large polarization is generated, and the electric charge stored in the positive electrode and the negative electrode increases, whereby the capacitance can be greatly increased.

Also, in the solid ion capacitor of the present invention, it is preferable that the solid electrolyte contains an ion conductive compound having a Nasicon type crystal structure, and the ion conductive compound includes at least Li, Al, P, and O (oxygen).

This allows that only the Li ions can be moved in a state in which the O ions are disposed in the crystal lattice, and the electric field can be efficiently increased, so that a large increase in the capacitance can be effectively achieved.

Also, in the solid ion capacitor of the present invention, it is preferable that the solid electrolyte contains a glass component.

In this case, the solid electrolyte made of glass ceramic containing a glass component exhibits excellent stability to moisture, so that a solid ion capacitor being excellent in the hygroscopic resistance can be realized.

Also, in the solid ion capacitor of the present invention, it is preferable that electrodes are formed on both surfaces of the solid electrolyte.

Further, in the solid ion capacitor of the present invention, it is preferable that the solid electrolyte and electrodes are alternately laminated in a large number so that a first electrode is formed on one principal surface of the solid electrolyte and a second electrode having a polarity different from that of the first electrode is formed on the other principal surface of the solid electrolyte.

This allows that the solid ion capacitor can have a lamination structure similar to that of a laminated ceramic capacitor, whereby a solid ion capacitor being small and having a larger capacitance can be easily realized.

Also, in the solid ion capacitor of the present invention, it is preferable that an interface between the solid electrolyte and the electrodes has a fine uneven structure.

This can increase the electrode area and, in combination with the reduction in the layer thickness of the solid electrolyte, a solid ion capacitor with an outstandingly increased capacitance can be realized.

Further, in the solid ion capacitor of the present invention, it is preferable that the electrodes are formed from a non-valve action material that does not have a valve action.

This allows that an insulating layer is not formed at the interface between the solid electrolyte and the electrodes, so that the ion conductivity can be ensured, and a desired large amount of electric charge can be stored in the electrodes.

Also, it is preferable that the non-valve action material is a precious metal material, a transition metal material, an oxide material, a semiconductor material, or a combination of these.

Also, a method for using a solid ion capacitor according to the present invention is characterized in that any one of the aforementioned solid ion capacitors is used at a driving voltage of no greater than 3 V (not including 0 V).

This allows that, even when Li ions are used as an ion conductor, Li is not reduced, whereby deposition of Li metal can be avoided.

Further, in the method for using the solid ion capacitor of the present invention, it is preferable that the driving voltage is 1.5 to 3 V.

This allows that an outstandingly large capacitance can be obtained as compared with a conventional electric double layer capacitor, and specifically, the solid ion capacitor of the present invention can be used as a solid ion capacitor of about 1000 to 3000 μF/cm² in terms of specific capacitance.

Since the solid ion capacitor of the present invention contains a solid electrolyte formed to have a thickness no greater than 200 μm, the electric field is applied to the whole solid electrolyte, and the electric charge in the near-field of the electrode can move to the near-field of the electrode on the opposite side, so that extremely large polarization is generated.

In this manner, the electric field application area increases, and the polarization formed by the electric charge that moves by the electric field becomes extremely large, so that the electric charge stored in the positive electrode and the negative electrode increases, whereby the capacitance can be greatly increased.

According to the method for using the solid ion capacitor of the present invention, the aforementioned solid ion capacitor is used at a driving voltage of no greater than 3 V (not including 0 V), so that, even when Li ions are used as an ion conductor, Li is not reduced, whereby deposition of Li metal can be avoided.

The above and other objects, features, and advantages of the invention will become more apparent from the following description.

### BRIEF EXPLANATION OF THE DRAWINGS

FIG. 1 is a cross-sectional view schematically showing one embodiment (first embodiment) of a solid ion capacitor according to the present invention.

FIGS. 2(a) to 2(c) are diagrams illustrating an operation principle of an electric double layer capacitor.

FIGS. 3(a) to 3(c) are diagrams illustrating an operation principle of a solid ion capacitor.

FIG. 4 is a cross-sectional view schematically showing a second embodiment of a solid ion capacitor according to the present invention.

FIG. 5 is a graph showing a voltage profile of a charging/discharging cycle in the Examples.

FIG. 6 is a graph showing change of the discharging current with lapse of time in the Examples.

FIG. 7 is a graph showing a relationship between the thickness of a solid electrolyte and the specific capacitance in the Examples.

FIG. 8 is a graph showing a relationship between the driving voltage and the specific capacitance in the Examples.

### DETAILED DESCRIPTION OF THE INVENTION

Next, embodiments of the present invention will be described in detail.

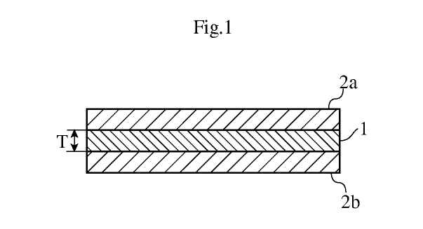

FIG. 1 is a cross-sectional view schematically showing one embodiment (first embodiment) of a solid ion capacitor according to the present invention, in which the solid ion capacitor has a positive electrode 2a and a negative electrode 2b (electrodes) formed on both principal surfaces of a solid electrolyte 1.

Specifically, the solid electrolyte 1 is formed to have a thickness T no greater than 200 μm.

Next, the reason why the solid electrolyte 1 is set to have a thickness no greater than 200 μm will be described by making comparison with a conventional electric double layer capacitor using a liquid electrolyte.

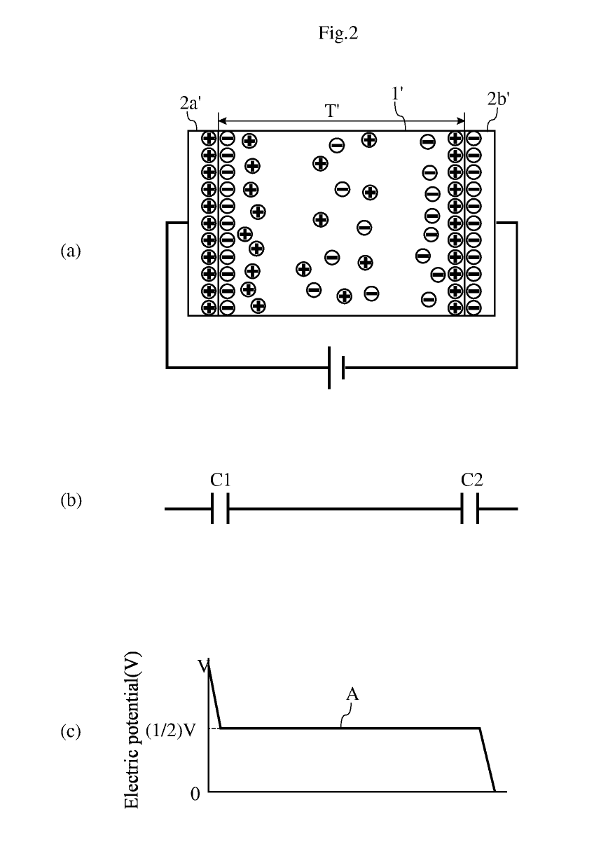

FIGS. 2(a) to 2(c) are diagrams illustrating an operation principle of an electric double layer capacitor, in which FIG. 2(a) is a drawing schematically illustrating the electric double layer capacitor; FIG. 2(b) shows an equivalent circuit of FIG. 2(a); and FIG. 2(c) shows an electric potential distribution of FIG. 2(a).

In the electric double layer capacitor, a positive electrode 2a′ and a negative electrode 2b′ are immersed in a liquid electrolyte 1′. Further, before a voltage is applied between the positive electrode 2a′ and the negative electrode 2b′, charged particles in the liquid electrolyte 1′ are irregularly distributed in the liquid electrolyte 1′. However, in case that a voltage is applied between the positive electrode 2a′ and the negative electrode 2b′, anions in the liquid electrolyte 1′ and cations in the positive electrode 2a′ form pairs to be distributed at the interface between the positive electrode 2a′ and the liquid electrolyte 1′, and cations in the liquid electrolyte 1′ and anions in the negative electrode 2b′ form pairs to be distributed at the interface between the negative electrode 2b′ and the liquid electrolyte 1′. Consequently, cations and anions are distributed in a layer form at the contact interface on the positive electrode 2a′ side, and anions and cations are distributed in a layer form at the contact interface on the negative electrode 2b′ side, whereby an electric double layer is formed.

In such an electric double layer capacitor, the electric charge is stored by the electric double layer formed during the charging, and two capacitors, that is, a capacitor C1 and a capacitor C2 are formed as shown in FIG. 2(b).

Also, the part of the liquid electrolyte 1′ except for the electric double layer functions simply as a conductor on the equivalent circuit. Further, the cations in the liquid electrolyte 1′ tend to be attracted to the anions that form an electric double layer on the positive electrode 2a′ side, so that the range where the force that attracts the anions in the positive electrode 2a′ is applied, that is, the electric field application area, is restricted to the near-field area of the positive electrode 2a′, and shielding is made so that the electric field application area does not penetrate into the inside of the liquid electrolyte 1′. Similarly, since the anions in the liquid electrolyte 1′ tend to be attracted to the cations that form an electric double layer on the negative electrode 2b′ side, shielding is made so that the electric field application area does not penetrate into the inside of the liquid electrolyte 1′ also in the near-field area of the negative electrode 2b′.

In response to this, the electric potential distribution of the electric double layer capacitor is a distribution in which, as shown in FIG. 2(c), a sharp decrease is generated from the electric potential V of the interface between the positive electrode 2a′ and the liquid electrolyte 1′ over to the near-field area of the positive electrode 2a′. Consequently, most of the liquid electrolyte 1′ forms a flat part A having an electric potential ((½) V) of about ½ of the electric potential V of the interface, and further, the electric potential sharply decreases until it becomes 0 from the near-field area of the negative electrode 2b′ over to the contact interface between the negative electrode 2b′ and the liquid electrolyte 1′.

Further, in the electric double layer capacitor, the voltage is only applied to the part where the electric double layer is formed, so as to store electric charge, so that the electric field applied to the capacitors C1 and C2 cannot be increased even when the distance T′ between the positive electrode 2a′ and the negative electrode 2b′ is shortened.

In other words, in the electric double layer capacitor, the specific capacitance is not dependent on the thickness of the electrolyte, so that the electrode area must be increased in order to increase the specific capacitance. However, since there is a limit in increasing the electrode area, it is said that the specific capacitance can be obtained only up to about 25 μF/cm².

On the other hand, in the solid ion capacitor of the present invention, the electric field application area in the solid electrolyte 1 can be increased by reducing the layer thickness T of the solid electrolyte 1, whereby the capacitance can be greatly increased without increasing the electrode area.

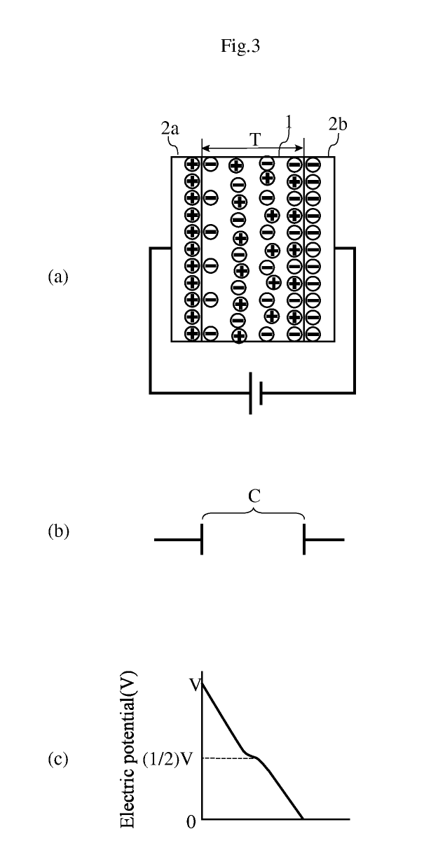

FIGS. 3(a) to 3(c) are diagrams illustrating an operation principle of a solid ion capacitor of the present invention, in which FIG. 3(a) is a drawing schematically illustrating the solid ion capacitor; FIG. 3(b) shows an equivalent circuit of FIG. 3(a); and FIG. 3(c) shows an electric potential distribution of FIG. 3(a).

In the solid electrolyte 1, only one ion out of the cation and the anion moves in the solid, and the other ion forms a crystal lattice and does not move. For example, in the case in which the solid electrolyte 1 is formed of a cation conductive compound containing cations such as Li ions, even when a voltage is applied between the positive electrode 2a and the negative electrode 2b, the anion does not move easily from the crystal lattice, whereas the cation moves in the solid electrolyte 1. Therefore, when the layer thickness of the solid electrolyte 1 is reduced, an extremely thin electric double layer, like the one that appears when the liquid electrolyte is used, is hardly formed at the interface between the solid electrolyte 1 and the positive electrode 2a or the negative electrode 2b, and the electric field application area reaches the inside of the solid electrolyte 1. In other words, when the layer thickness of the solid electrolyte 1 is reduced, no shielding against the electric field is made in the near-field area of the positive electrode 2a and the negative electrode 2b, different from the case of the electric double layer capacitor, so that the electric field penetrates into the inside of the solid electrolyte 1 to increase the electric field application area, and a single capacitor C is formed as shown in FIG. 3(b).

In this case, the electric potential distribution of the solid ion capacitor decreases approximately linearly from the positive electrode 2a over to the negative electrode 2b as shown in FIG. 3(c), and a flat part is not formed or only a flat part with an extremely short distance is formed in the solid electrolyte 1.

In this manner, in the solid ion capacitor, the electric field application area can be increased by reducing the layer thickness of the solid electrolyte 1, and the single capacitor C can be formed between the positive electrode 2a and the negative electrode 2b with the solid electrolyte 1 interposed therebetween. Further, by increase of the electric field application area, the polarization formed by ions that are displaced by the electric field increases, so that the electric charge stored in the positive electrode 2a and the negative electrode 2b increases, whereby the capacitance per volume can be greatly increased. Specifically, the specific capacitance can be greatly increased to be 120 times or more as large as that of a conventional electric double layer capacitor.

For this purpose, the thickness T of the solid electrolyte 1 must be reduced to be no greater than 200 μm. That is, if the thickness T of the solid electrolyte 1 exceeds 200 μm, the thickness T of the solid electrolyte 1 is too large, so that a area where the electric field is not applied will remain in the central part of the solid electrolyte, disadvantageously resulting in an electric potential distribution similar to the one in FIG. 2(c) described above.

Although the material for forming the solid electrolyte 1 is not particularly limited as long as the material contains an ion conductive compound whose ions move in the solid electrolyte 1, the material preferably includes a Nasicon type crystal structure in which the apexes of a regular octahedral structure and the apexes of a regular tetrahedral structure are commonly owned and three-dimensionally arranged. The Nasicon type crystal structure has a large void in the crystal structure, in which the cation easily moves, whereas the movement of the anion is extremely difficult. Also, among such ion conductive compounds, a mixed phase of a Nasicon type crystal structure and AlPO₄ (berlinite) is more preferable. As an ion conductor element, Li can be preferably used. With regard to other components contained in the ion conductive compound, a compound in a composite oxide form containing Al, P and Ti, Ge, or the like can be preferably used.

Further, as the ion conductive compound, glass ceramic containing a glass component such as SiO₂ is also preferably used. Although ceramic containing Li typically has hygroscopicity and is unstable to moisture, the ceramic exhibits excellent stability to moisture by allowing a glass component to be contained, whereby an improvement in the hygroscopic resistance can be achieved.

Also, although the electrode material used in the positive electrode 2a and the negative electrode 2b is not particularly limited, a non-valve action material that does not have a valve action, for example, a precious metal material such as Au, Pt, and Pd, or a transition metal material such as Ni, Cu, Cr, Mn, Fe, and Co can be preferably used, and also an oxide material or a semiconductor material such as SiC can be used as well.

In contrast, a valve-action metal having a valve action such as Al, Ti, Ta, Nb, or an alloy containing these metals is not preferable because there is a fear that an insulating layer may be easily formed at the interface between the positive electrode 2a or the negative electrode 2b and the solid electrolyte 1 at the time of manufacturing the solid ion capacitor, thereby causing decrease in the capacitance.

Also, with a view to allowing the interface between the solid electrolyte 1 and the positive electrode 2a or the negative electrode 2b to have a fine uneven structure, it is preferable to perform surface roughening of the interface. This allows that the electrode area is increased and, in combination with the reduction in layer thickness of the solid electrolyte 1, the specific capacitance can be further increased.

The solid electrolyte 1 is a sintered body formed by a firing treatment as will be described later, so that the surface has a certain degree of uneven structure at the stage of being sintered. Therefore, the interface can be easily made to have a fine uneven structure by forming the positive electrode or negative electrode after performing a polishing treatment to allow the surface of the sintered body to have fine unevenness or by forming the positive electrode or negative electrode without polishing the sintered body. Also, the fine uneven structure can be formed by suitably performing an etching treatment or the like on both principal surfaces of the solid electrolyte 1.

Also, the solid ion capacitor of the present embodiment is preferably used at a driving voltage of no greater than 3 V. In the case of a solid ion capacitor, Li ions are typically used as the ion conductor.

Since the oxidation-reduction potential of Li ions is 3.045 V, the Li ions are reduced to Li metal to be metalized, if the driving voltage exceeds 3 V, thus the Li ions are not suitable for use.

On the other hand, if the driving voltage is lower than 1.5 V, the driving voltage is too low, so that the thickness of the electric field application area is thought to become small, and it appears that a desired sufficiently large capacitance cannot be obtained.

Therefore, in the solid ion capacitor, particularly in the case in which Li ions are used as a cation of the ion conductive compound, the driving voltage is preferably no greater than 3 V and is more preferably 1.5 to 3 V.

Next, a method for producing the solid ion capacitor will be described.

First, predetermined amounts of source materials are weighed and mixed. For example, in the case in which the ion conductive compound to be manufactured is a mixed phase of a Nasicon type crystal phase including Li, Ti, P, and O and AlPO₄, a Li compound such as Li₂CO₃, a P compound such as AlPO₄ or H₃PO₄, and further a Ti compound such as TiO₂ are prepared as source materials, and predetermined amounts of these source materials are weighed and mixed to obtain a mixture.

Next, this mixture is subjected to a thermal treatment with a predetermined thermal treatment profile to manufacture an ion conductive compound.

Besides, in the case of allowing the ion conductive compound to contain a glass component, it is preferable that a predetermined amount of a glass material containing a Si compound such as SiO₂ is weighed and mixed with the source materials and, after the mixture is heated and fused, the resultant is vitrified by being quenched, followed by performing a thermal treatment with the predetermined thermal treatment profile, so as to manufacture the ion-conducting compound.

Subsequently, after this ion conductive compound is subjected to wet grinding, a binder, a solvent, a plasticizer, and the like are added, and the resultant is sufficiently subjected to wet mixing to obtain a slurry. Further, this slurry is dried and granulated, and thereafter press-molded into a pellet shape or the like, so as to obtain a molded article having a thickness after firing no greater than 200 μm.

The binder, the solvent, the plasticizer, and the like are not particularly limited, so that, for example, a polyvinyl butyral resin or the like can be used as the binder; n-butyl acetate or the like can be used as the solvent; and dibutyl phthalate or the like can be used as the plasticizer.

Thereafter, the molded article is fired by setting the firing temperature to be, for example, 400° C. to 1250° C. and setting the firing time to be, for example, 3 to 70 hours, thereby to manufacture the solid electrolyte 1.

Next, as the electrode material, preferably, a non-valve action material that does not have a valve action, for example, a precious metal material such as Au, Pt, or Pd, a transition metal material such as Ni, Cu, Cr, Mn, Fe, or Co, an oxide material, or a semiconductor material such as SiC is prepared and, by using this electrode material, the positive electrode 2a and the negative electrode 2b are formed on both principal surfaces of the solid electrolyte 1.

The method for forming the positive electrode 2a and the negative electrode 2b is not particularly limited, so that, for example, an arbitrary method such as a thin film-forming method such as a sputtering method or a vacuum vapor deposition method, a coating method of applying and baking a paste, a plating method such as electrolytic plating, or a thermal spraying method can be used.

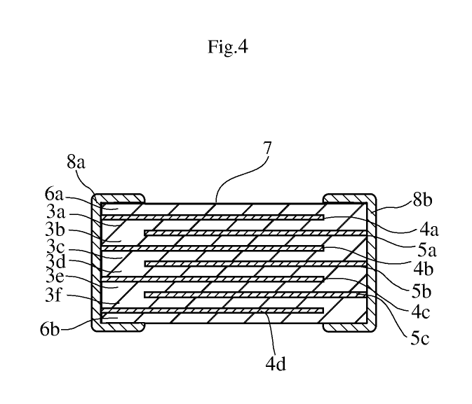

FIG. 4 is a cross-sectional view schematically showing a second embodiment of a solid ion capacitor according to the present invention. In the present second embodiment, the solid ion capacitor has a lamination structure.

That is, in this solid ion capacitor, solid electrolytes 3a-3f and positive electrodes 4a-4d or negative electrodes 5a-5c are alternately laminated in a large number so that the positive electrodes (first electrodes) 4a-4d are formed on one principal surface of the solid electrolytes 3a-3f, and the negative electrodes (second electrodes) 5a-5c are formed on the other principal surface of the solid electrolytes 3a-3f. Also, outer-claddings 6a, 6b made of the same material as the solid electrolytes 3a-3f are provided as a layer above the positive electrode 4a and as a layer below the positive electrode 4d, and these solid electrolytes 3a-3f, positive electrodes 4a-4d, negative electrodes 5a-5c, and outer-claddings 6a, 6b form an element main body 7. Further, a first external electrode 8a and a second external electrode 8b are formed at both ends of the element main body 7, in which the first external electrode 8a is electrically connected to the positive electrodes 4a-4d, and the second external electrode 8b is electrically connected to the negative electrodes 5a-5c.

In this manner, in the present second embodiment, the solid electrolytes 3a-3f having a reduced layer thickness of no greater than 200 μm and the positive electrodes 4a-4d or the negative electrodes 5a-5c are alternately laminated in a large number so that the positive electrodes 4a-4d are formed on one principal surface of he solid electrolytes 3a-3f, and the negative electrodes 5a-5c are formed on the other principal surface of the solid electrolytes 3a-3f, so that the solid ion capacitor has a lamination structure similar to that of a laminated ceramic capacitor, and a solid ion capacitor being small and having a larger capacitance can be easily realized. In particular, by forming the solid ion capacitor so that the junction surface between the solid electrolytes 3a-3f and the positive electrodes 4a-4d or the negative electrodes 5a-5c may have a fine uneven structure, the electrode area can be increased, so that, by combination with the reduction in layer thickness of the solid electrolyte 1, a solid ion capacitor having an outstandingly increased capacitance can be realized.

Besides, the solid ion capacitor of this second embodiment can be easily produced in the following method.

First, an ion conductive compound is manufactured according to the same method and procedure as those in the first embodiment.

Subsequently, after this ion conductive compound is sufficiently subjected to wet grinding, a binder, a solvent, a plasticizer, and the like are added and the resultant is subjected to wet mixing to manufacture a slurry. Thereafter, this slurry is subjected to molding processing by using a molding processing method such as a doctor blade method, so as to manufacture green sheets.

Next, an electrode paste containing an electrode material is prepared, and the electrode paste is printed onto the green sheets to form a coating film having a predetermined pattern. Further, the green sheets on which the coating film has been formed are appropriately laminated in a predetermined direction, and the resultant is heated and pressed with the green sheet on which the coating film is not formed being disposed as the uppermost layer, so as to manufacture a laminated molded article.

Subsequently, after this laminated molded article is cut to have a predetermined dimension, the resultant is put into a sagger and fired, so as to obtain the element main body 7 in which the solid electrolytes 3a-3f and the positive electrodes 4a-4d or the negative electrodes 5a-5c are alternately laminated.

Further, a paste for external electrodes is prepared, and the paste for external electrodes is applied to both ends of the element main body 7 and baked, so as to form the first and second external electrodes 8a and 8b, whereby a solid ion capacitor having a lamination structure can be formed.

Besides, it goes without saying that the present invention is not limited to the aforementioned embodiments and can be modified within the range that does not depart from the gist thereof.

Next, examples of the present invention will be specifically described.

### EXAMPLES

### Manufacturing of Samples

As source materials, H₃PO₄, Li₂CO₃, Al(PO₃)₃, SiO₂, and TiO₂ were prepared, and predetermined amounts of these source materials were weighed and mixed to obtain a mixture.

Subsequently, this mixture was put into a fusion kiln and fused by being heated at a temperature of 1500° C. for 3 hours. The fused mixture was let to flow out into a mold at a temperature of 300° C. from a slit-shaped hole disposed at the bottom of the fusion kiln, followed by quenching to obtain a glassy molded article.

Subsequently, this glassy molded article was thermally treated with a predetermined thermal treatment profile, so as to obtain a Li ion conductive compound. Specifically, after the temperature of a thermal treatment furnace was raised from room temperature to 600° C. at a rising rate of 300° C./h, the temperature of the thermal treatment furnace was raised to 950° C. at a rising rate of 100° C./h. Thereafter, the thermal treatment temperature was maintained at 950° C. for 10 hours, and thereafter the Li ion-conducting compound was gradually cooled to room temperature, thereby to obtain a crystallized Li ion conductive compound.

An X-ray diffraction spectrum of the Li ion conductive compound was measured by using an X-ray diffraction apparatus, and it was confirmed that the Li ion conductive compound was a mixed phase of a Nasicon type crystal of LiTi₂(PO₄)₃ and an AlPO₄ (berlinite) type crystal.

Further, the component composition of the Li ion conductive compound was measured by using an ICP optical emission spectrometer (ICAP6300 manufactured by Thermo Fisher Scientific K.K.), and it was confirmed that the composition was Li_{1.21}Al_{0.64}Ti_{1.53}Si_{0.16}P_{2.82}O₁₂.

Subsequently, after the Li ion conductive compound was subjected to wet grinding, a polyvinyl butyral resin as a binder, n-butyl acetate as a solvent, and dibutyl phthalate as a plasticizer were added, and the resultant was sufficiently subjected to wet mixing to obtain a slurry. Further, after the slurry was dried and granulated, the resultant was subjected to press-molding, thereby to manufacture each of the molded articles so that the thickness after firing would be 80 μm (Sample No. 1), 120 μm (Sample No. 2), 160 μm (Sample No. 3), 310 μm (Sample No. 4), and 490 μm (Sample No. 5).

Thereafter, the aforementioned molded article was fired at a firing temperature of 800° C. for 12 hours, thereby to manufacture a solid electrolyte.

Next, Au was prepared as a positive electrode material and a negative electrode material, and a sputtering treatment was carried out on both principal surfaces of the solid electrolyte with Au used as a target, whereby a positive electrode and a negative electrode made of Au were formed respectively on both principal surfaces of the solid electrolyte, so as to obtain the samples of Sample Nos. 1-5. Besides, the electrode surface area of the positive electrode and the negative electrode was 0.25 cm².

### Evaluation of Samples

With respect to each of the samples of Sample Nos. 1-5, charging and discharging were carried out with a predetermined charging/discharging profile, and the specific capacitance was measured from the discharging current.

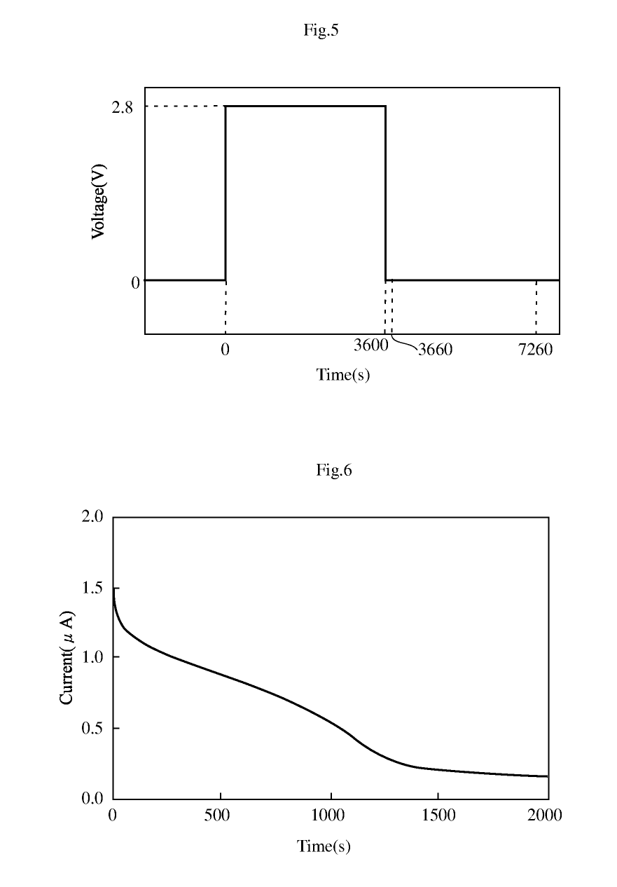

FIG. 5 is a graph showing the charging/discharging profile used in the present example.

Charging was carried out at a constant charging voltage of 2.8 V for 3600 seconds and, at the time point of 3660 seconds after 60 seconds of an opening time had passed, discharging was carried out for 3600 seconds, and the specific capacitance was calculated based on the discharging current thereof and the electrode surface area.

FIG. 6 is a graph showing change of the discharging current of Sample No. 3 with lapse of time, in which the abscissa axis represents the time (sec), and the ordinate axis represents the electric current (μA).

The specific capacitance was determined to be 1300 μF/cm² by integrating this discharging current curve and calculating the specific capacitance from the integrated value thereof and the electrode surface area.

With respect to other samples, the specific capacitance was determined similarly based on the discharging current and so forth.

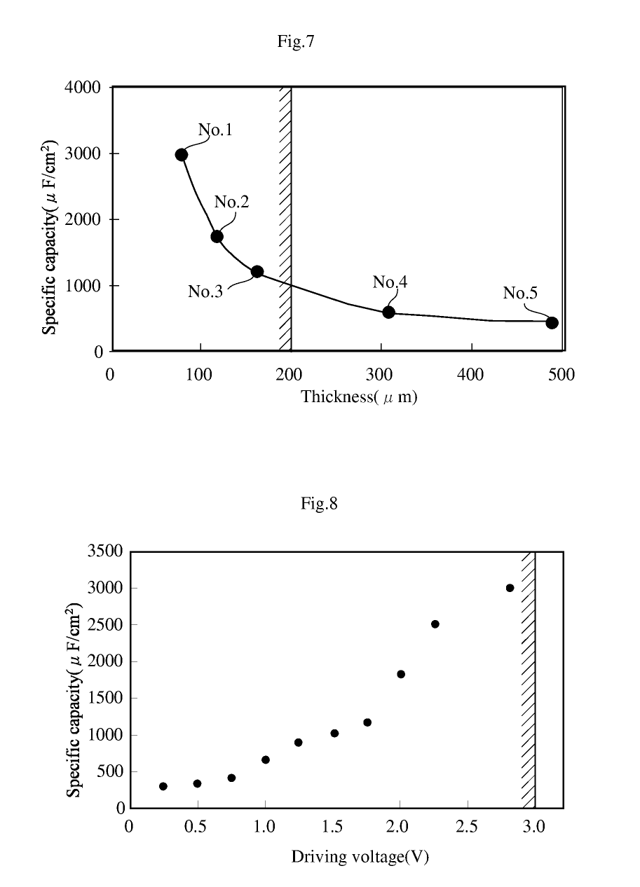

FIG. 7 is a graph showing a relationship between the thickness of the solid electrolyte and the specific capacitance, in which the abscissa axis represents the thickness (μm) of the solid electrolyte, and the ordinate axis represents the specific capacitance (μF/cm²).

As will be clear from this FIG. 7, the following has been confirmed. With respect to Sample Nos. 4 and 5 in which the thickness exceeds 200 μm, the specific capacitance decreases to be less than 1000 μF/cm². In contrast, with respect to Sample Nos. 1-3 in which the thickness is no greater than 200 μm, a large specific capacitance of 1000 μF/cm² or more is obtained. In particular, it has been found out that, with respect to Sample No. 1 in which the thickness is 80 μm, the specific capacitance is outstandingly improved to be 3000 μF/cm².

Next, with respect to the sample of Sample No. 1 (thickness: 80 μm), 10 different kinds of voltages ranging from 0.25 V to 3 V were applied, and the specific capacitance was measured in the same manner as described above, thereby to examine the relationship between the driving voltage and the specific capacitance.

FIG. 8 shows a measurement result thereof. The abscissa axis represents the driving voltage (V), and the ordinate axis represents the specific capacitance (μF/cm²).

As will be clear from this FIG. 8, it has been found out that the solid ion capacitor can be used at a driving voltage of no greater than 3 V and, in order to obtain a specific capacitance of 1000 μF/cm² or more, the driving voltage is preferably 1.5 to 3 V.

Besides, the aforementioned example is merely one example of an embodiment of the present invention, so that the present invention is not limited to this example. For example, with respect to the element species contained in the solid electrolyte, similar functions and effects can be obtained, for example, by allowing an element such as Ge to be contained in addition to Ti or in place of Ti.

A solid ion capacitor with greatly increased capacitance as compared with a conventional electric double-layer capacitor can be realized.

### DESCRIPTION OF REFERENCE SYMBOLS

solid electrolyte

2a positive electrode

2b negative electrode

3a-3f solid electrolyte

4a-4d positive electrode

5a-5c negative electrode

1. A solid ion capacitor comprising a solid electrolyte having a thickness no greater than 200 μm.

2. The solid ion capacitor according to claim 1, wherein the solid electrolyte contains an ion conductive compound having a Nasicon type crystal structure.

3. The solid ion capacitor according to claim 1, wherein the ion conductive compound includes at least Li, Al, P, and O.

4. The solid ion capacitor according to claim 2, wherein the solid electrolyte contains a glass component.

5. The solid ion capacitor according to claim 1, further comprising electrodes on opposed surfaces of the solid electrolyte.

6. The solid ion capacitor according to claim 5, wherein, of the electrodes, a first electrode on a first surface of the solid electrolyte and a second electrode on a second surface of the solid electrolyte opposite the first surface have different polarities.

7. The solid ion capacitor according to claim 5, wherein an interface between the solid electrolyte and the electrodes has a fine uneven structure.

8. The solid ion capacitor according to claim 5, wherein the electrodes are a non-valve action material that does not have a valve action.

9. The solid ion capacitor according to claim 8, wherein the non-valve action material is a precious metal material, a transition metal material, an oxide material, a semiconductor material, or a combination thereof.

10. A capacitor comprising a plurality of the solid ion capacitors according to claim 5, alternately laminated so that a first electrode is on a first surface of each solid electrolyte and a second electrode having a polarity different from that of the first electrode is on a second surface of each solid electrolyte.

11. The capacitor according to claim 10, wherein an interface between the solid electrolyte and the first and second electrodes has an uneven structure.

12. The capacitor according to claim 10, wherein the first and second electrodes are a non-valve action material that does not have a valve action.

13. The capacitor according to claim 12, wherein the non-valve action material is a precious metal material, a transition metal material, an oxide material, a semiconductor material, or a combination thereof.

14. A method for using the solid ion capacitor according to claim 1 by applying a driving voltage of greater than 0 V and no greater than 3 V.

15. The method for using the solid ion capacitor according to claim 14, wherein the driving voltage is 1.5 to 3 V.
